(19) United States
(12) Patent Application Publication
(10) Pub. No.: US 2007/0189932 A1
(43) Pub. Date: Aug. 16, 2007

(54) Antimicrobial reusable plastic container

(76) Inventors: Joe Glenn, Belton, SC (US); Kirk Vogt, Simpsonville, SC (US); David Bridges, Gaffney, SC (US)

Correspondence Address: Milliken & Company, P.O. Box 1927, Spartanburg, SC, 29304, US

(21) Appl. No.: 11/351,736

(22) Filed: Feb. 10, 2006

(51) Int. Cl. B01L 11/00

(52) U.S. Cl. 422/101

(57) ABSTRACT

The invention relates to an antimicrobial reusable plastic container comprising four polymeric sides and a polymeric base, wherein at least one of the sides or the bottom is at least partially comprises fabric, and wherein the polymeric sides, polymeric base, and/or the fabric comprise an antimicrobial chemistry.

### TECHNICAL FIELD

This invention relates generally to reusable plastic containers containing an antimicrobial agent. More particularly, the invention relates to a foldable reusable plastic container where at least one of the sides of the container is fabric and the plastic and/or the fabric contains an antimicrobial agent.

### BACKGROUND

There has been a great deal of attention in recent years given to the hazards of bacterial contamination from potential everyday exposure. Noteworthy examples of such concern include the fatal consequences of food poisoning due to certain strains of Escherichia coli being found within undercooked beef in fast food restaurants; Salmonella contamination causing sicknesses from undercooked and unwashed poultry food products; and illnesses and skin infections attributed to Staphylococcus aureus, yeast, and other unicellular organisms. With such an increased consumer interest in this area, manufacturers have begun introducing antimicrobial agents within various household products and articles.

Packaging for various foods using reusable plastic containers are now used for general purposes as an indispensable packaging, shipping, and displaying means. In addition to the basic requirements for packaging, to prevent microbial contamination of foods, there has been a demand for packaging to serve to maintain freshness of foods. For example, various studies have been directed to incorporation of antibacterial agents or antifungal agents into raw resins of packaging films or containers.

Silver-containing inorganic microbiocides have recently been developed and utilized as antimicrobial agents on and within a plethora of different substrates and surfaces. In particular, such microbiocides have been adapted for incorporation within plastic compositions and fibers in order to provide household and consumer products which exhibit inherent antimicrobial characteristics. Various antibacterial agents which can be added in raw resins have been proposed in the field of general food packaging. When it is considered that an antibacterial agent that migrates out from a packaging film or container would contaminate the food, nonmigratory substances, e.g., antibacterial zeolites which contain a metal having antibacterial activity such as silver, are regarded as favorable.

All patent documents referenced in this specification are hereby specifically incorporated by reference in their entirety as if fully set forth herein. Past plastic compositions and articles comprising silver-containing antimicrobial agents include U.S. Pat. No. 5,405,644 to Ohsumi et al., which includes the addition of certain triazoles, U.S. Pat. No. 4,938,955 to Niira, deceased et al. (also including benzotriazole stabilizers), U.S. Pat. No. 5,750,609 to Nosu et al., which discloses an ultraviolet protective agent for incorporation within a variety of compositions, such as films, fibers, cosmetics, and the like, comprising a zinc-based hydrotalcite which acts solely as an ultraviolet absorber. However, these particular methods and plastics have proven to be costly, particularly since relatively high concentrations of the expensive stabilizing compounds are required, and do not provide any appreciable increase of available silver on the surface of such articles. Also, as these stabilizers are not thermally stable, they introduce additional processing complications.

### SUMMARY

The present invention provides advantages and/or alternatives over the known art by providing an antimicrobial reusable plastic container comprising four sides and a base, wherein at least one of the sides or the bottom is at least partially comprises fabric, and wherein the fabric and/or the plastic comprises an antimicrobial chemistry.

### BRIEF DESCRIPTION OF THE DRAWINGS

The present invention will now be described by way of example only, with reference to the accompanying drawings which constitute a part of the specification herein and in which:

FIG. 1 is a perspective illustration of a shipping container shown in the erect condition.

FIG. 2 is a perspective illustration of the shipping container of FIG. 1 folded flat.

FIG. 3 is a perspective illustration of a sidewall and an end wall of the container of FIG. 1, showing a tab and slot arrangement used to keep the container erect.

FIG. 4 is a schematic exploded view of a mold bottom half with a cavity, a fabric insert and a mold top.

### DETAILED DESCRIPTION

Shipping containers are used to ship a wide variety of goods. One type of shipper forms a box that can be knocked down after use and then reused. This kind of container, called reusable plastic container, should be strong enough to carry its intended load safely and be as light as possible to reduce unnecessary shipping costs. It should also fold as compactly as possible to make return handling convenient.

The reusable plastic container of the invention has four sides and a base, where at least one of the sides or the base comprise fabric and the fabric and/or the plastic contain antimicrobial chemistry.

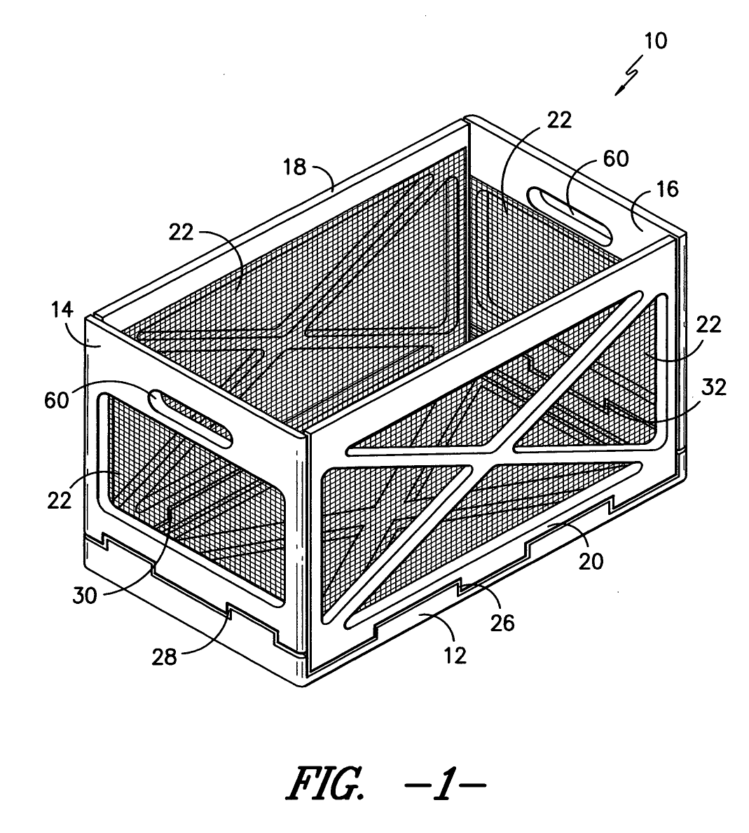

FIG. 1 shows a shipping container 10 of the invention. The shipping container has a bottom 12 and 4 sides (two end sides 14, 16 and two sides 18, 20). At least one of the sides or bottom is at least partially fabric 22. In the embodiment shown in FIG. 1, each of the sides and bottom include a fabric 22, that is insert molded in place. The sidewalls 18, 20 and end walls 14, 16 are hinged to the bottom 12.

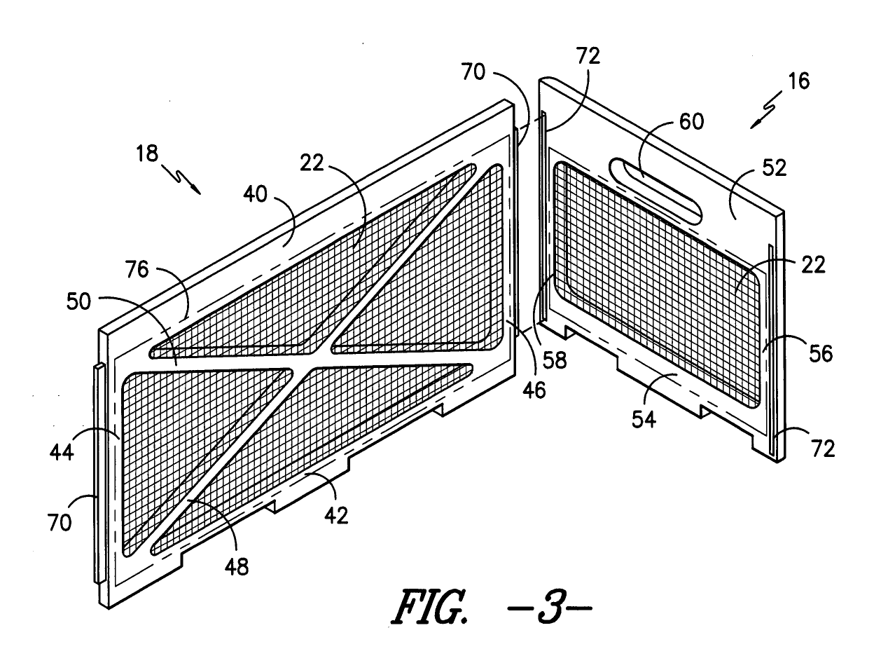

The sides 14, 16, 18, and 20 and bottom 12 of the shipping container 10 are preferably formed of a thermoplastic material. Each of the walls and bottom is made with an insert molded fabric 22 covering the inside surface. This is accomplished by placing a panel of fabric of the appropriate size in the mold before the mold is closed to inject the plastic forming the rails and stiles of the wall (or bottom). The fabric 22 (FIG. 3) is sized to form a band 76 around the margin where it overlaps with the rails 40, 42 and stiles 46, 48.

Because the fabric 22 is present in the mold when the thermoplastic material is injected, there is an intimate mechanical bond between the fabric and the plastic. To enhance this mechanical bond, the marginal band 76 may be perforated before molding. The injected plastic material fills the openings so formed. As a result of insert molding the fabric panels in place, there are fewer nooks and crannies where the fabric and walls are joined, making the shipping container easier to clean for reuse than would be a similar shipping container with a fabric separately attached to the walls. Moreover, the fabric is essentially permanently attached to the walls, and cannot be separated from the walls without destroying either the fabric or the wall.

The reusable plastic container may be any container with 4 sides and a base, but preferably it is a light weight collapsible container with fabric in at least 1 of the sides or base. Preferably, the fabric is in at least a portion of 2 or more sides, more preferably in at least a portion of all 4 sides. Additionally, it is preferred that the base is also least a portion fabric. Preferably, at least a portion of at least one of the sides is rigid. Preferably, the fabric is between 10 and 95% of the surface area of the base, more preferably 25 to 90%, more preferably 70 to 90% of the surface area of the base. Additionally, the fabric is preferably between 5 and 75% of the surface area of the sides, more preferably 25 to 70%, more preferably 40 to 65% of the surface area of the sides. In one embodiment, the container may also have a lid and the lid may have a portion of the surface area bring fabric. More preferably, at least 2 of the sides are rigid. This creates a shipping container that is light weight and strong. Such a container is described in US Application 2004/0112895.

The fabric may be of any kind that can withstand the injection molding process. The fabric must have a sufficiently high melting point that it will not melt during the molding process, and it must have sufficient mechanical strength to withstand the flow of molten plastic within the mold. If a thermoplastic material is used for the insert, a quasi chemical bond can occur with the material forming the rails and stiles. This happens as the hot material forming the frame diffuses into the fabric material, making a particularly permanent connection between the two.

In one embodiment, the fabric used in the container comprises an antimicrobial agent or chemistry as a wash-durable antimicrobial silver-ion containing treatment. The yarns making up the textile may contain the antimicrobial agent, or the textile may be treated or coated with a composition containing an antimicrobial.

In one embodiment, the yarns making up the textile are a thermoplastic, preferably polypropylene, and the polypropylene yarns comprise an antimicrobial chemistry. This is preferred because no additional surface treatments to the textile are necessary to have the antimicrobial properties. Preferably, the antimicrobial agent is compounded into the polymer, extruded into yarns, and formed into a textile. In another embodiment, the textile has a finish comprising a silver-ion containing antimicrobial compound. This is preferred because the finish can be applied to any textile and does not require the additional step of compounding in the antimicrobial chemistry into the yarns. In another embodiment, a coating material containing an antimicrobial may be applied to yarns or the fabric to give the fabric antimicrobial properties. Preferably, these coatings are polyvinyl chloride or polyolefin because these resins provide washfastness by adhering silver to the target yarn and/or fabric surface.

Whether the antimicrobial is in the textile or in a coating on the textile, antimicrobial fabric exhibits a log kill rate for Staphylococcus aureus of at least 1.5 log units per 24 hours, preferably above 2.0, more preferably above 3.0, and a log kill rate for Klebsiella pneumoniae of at least 1.5, preferably above 2.0, and more preferably above 3.0, both as tested in accordance with AATCC Test Method 100-1993 for 24 hour exposure, after at least 10 washes, said washes being performed in accordance with the wash procedure as part of AATCC Test Method 130-1981. Even more preferable log kill rates exhibited by the inventive treated substrates are at least 3.2 and 3.2, respectively for S. aureus and K. pneumoniae; still more preferably these log kill rates are 3.5 and 3.5, respectively; and most preferably these are 4.0 and 4.0, respectively. The wash durability test noted above is standard and, as will be well appreciated by one of ordinary skill in this art, is not intended to be a required or limitation within this invention. Such a test method merely provides a standard which, upon 10 washes in accordance with such, the inventive treated substrate will not lose an appreciable amount of its electrically non-conductive metal finish.

The fabric of the invention is selected to optimize its physical properties (strength, elasticity, abrasion) with the shipping container use. Fabrics may be made of natural fibers (for example, cotton, wool, ramie, hemp, linen, and the like), synthetic fibers (for example polyethylene, polypropylene, polybutylene, halogenated polymers, such as polyvinyl chloride, polyesters, such as polyethylene terephthalate, polyester/polyethers, polyamides, such as nylon 6 and nylon 6,6, polyurethanes, as well as homopolymers, copolymers, or terepolymers in any combination of such monomerspolyolefins, polyaramids, acetates, rayon, acylics, and the like), and inorganic fibers (for example fiberglass, boron fibers, and the like) or mixtures thereof. The yarn or fiber of the fabric may be of any denier, may be of multi- or mono-filament, may be false-twisted or twisted, or may incorporate multiple denier fibers or filaments into one single yarn through twisting, melting, and the like.

The fabric 22 may be of any standard construction, including knit, woven, or non-woven forms. The particular properties of the fabric 22 used may be selected according to the requirements of the goods to be shipped. The fabric can have a very wide mesh for air and water permeability or be tightly woven so as to be almost air and water impermeable. The fabric may be stiff or flexible, rigid or elastic. The fabric can be a woven, knitted, non-woven material, tufted materials, or the like. Woven textiles can include, but are not limited to, satin, poplin, leno, and crepe weave textiles. Knit textiles can include, but are not limited to, circular knit, warp knit, warp knit with weft insertion, and warp knit with a microdenier face. The textile may be flat, or may exhibit a pile.

The fabric may be dyed or colored to provide other aesthetic features for the end user with any type of colorant. Other additives may also be present on and/or within the textile, including antistatic agents, brightening compounds, nucleating agents, antioxidants, UV stabilizers, fillers, permanent press finishes, softeners, lubricants, curing accelerators, and the like. In one embodiment, the textiles have a finish containing soil release agents which improve the wettability and washability of the fabric. Additionally, other potential additives and/or finishes may include water repellent fluorocarbons and their derivatives, silicones, waxes, and other similar water-proofing materials.

The antimicrobial of the fabric comprises at least one type of silver-ion containing compounds, or mixtures thereof of different types. The term silver-ion containing compounds encompasses compounds which are either ion-exchange resins, zeolites, or, possibly substituted glass compounds (which release the particular metal ion bonded thereto upon the presence of other anionic species). The preferred metal-ion containing compound for this invention is an antimicrobial silver zirconium phosphate available from Milliken & Company, under the tradename ALPHASAN™. Other potentially preferred silver-containing antimicrobials in this invention is a silver-substituted zeolite available from Sinanen under the tradename ZEOMIC™ A J, or a silver-substituted glass available from Ishizuka Glass under the tradename IONPURE™, may be utilized either in addition to or as a substitute for the preferred species. Preferably this metal compound is present in an amount of from about 0.01 to about 5% owf, preferably from about 0.05 to about 3% owf, more preferably from about 0.1 to about 2% owf. The preferred procedures utilizing silver-ion containing compounds, such as either ALPHASAN™, ZEOMIC™ or IONPURE™ as preferred compounds (although any similar types of compounds which provide silver ions may also be utilized), exhausted on the target fabric or film surface and then overcoated with a binder resin. Alternatively, the silver-ion containing compound may be admixed with a binder within a dye bath, into which the target fabric is then immersed at elevated temperatures (i.e., above about 50° C.).

The shipping container shown in FIG. 1 includes a bottom and four walls all of which have fabric panels insert molded during the manufacturing process. It should be clear that one or more of the walls or the bottom may be made without the insert and either having an open frame or having a solid plastic panel closing the wall. Variations in the size of the fabric panels may be made according to the needs of the materials to be shipped in the container. In some applications the fabric panels 22 may cover the openings for the handles 60. For example, sidewalls could have a solid lower portion and fabric panels that span the upper portion. One or more walls (or the bottom) could be made with completely solid walls, for example to allow forced ventilation in one direction only.

In another embodiment, the plastic making up the sides 14,16, 18, and 20 and bottom 12 of the shipping container 10 contain an antimicrobial chemistry. Preferably, the sides 14, 16, 18, and 20 and bottom 12 comprise at least one silver-containing antimicrobial agent and from 0.1% to 1.25% by weight, preferably from about 0.2 to about 1.0%, more preferably from about 0.2 to about 0.5% by weight of at least one carboxylic acid salt component other than or in excess of an optional acid scavenger compound. The thermoplastic container preferably comprises at least one silver-containing antimicrobial agent and exhibits a surface-available amount of silver of at least 0.25 micrograms of silver/square decimeter, as measured by a salt-extraction test for 24 hours at room temperature.

Any plastic in which a silver-based antimicrobial agent may be properly incorporated can be utilized in this invention. For instance, and without intending any limitations therein, polyolefins, such as polyethylene, polypropylene, and polybutylene, styrenics, such as polystyrene, ABS, and the like, and polyesters, such as polyethylene terephthalate, may be utilized within this invention. Preferably, the plastic is a thermoplastic that can be molded into different shapes and sizes upon extrusion a molding with the silver-containing antimicrobial and the required excess amount of carboxylic acid salts. Thus, polyolefins, particularly polypropylene, and styrenics, particularly polystyrene, are preferred. Furthermore, such plastics preferably may be colored to provide other aesthetic features for the end user. Thus, the plastic may also comprise colorants, such as, for example, poly(oxyalkylenated) colorants, pigments, dyes, and the like, too. Other additives may also be present, including antistatic agents, brightening compounds, nucleating agents, clarifying agents, lubricants, flame retardants, antioxidants, UV stabilizers, fillers, and the like.

The term “surface-available silver” is intended to encompass the phenomenon of the detectable presence of available silver, either as metals or ions, on the target article's surface or, possibly from a distance very close to such surface but imbedded therein until extracted out with relative ease. Detection in this instance is accomplished through a particular method, wherein the sample article is immersed within an extracting solution, such as, a mixed salt solution (in this instance a sodium-potassium-phosphate buffer solution) for at least twenty-four hours at room temperature. After such time, the extract solution is then analyzed through, for example, and without intended limitation, Inductive Coupled Plasma spectroscopy (hereinafter referred to as ICP) for the presence of silver therein which would have been removed from the target thermoplastic during the extraction process. The detection of such silver thus indicates the availability of silver at or near the article's surface and thus correlates to an increase in activity in relation to the availability of such silver in such a manner.

The preferred silver-containing antimicrobial for the plastic is an inorganic silver-containing compound, including, without limitation, inorganic compounds such as silver zirconium phosphates available from Milliken & Company under the tradename ALPHASAN™ RC-2000, RC-5000, and RC-7000, although any silver-containing inorganic antimicrobial agent may also be utilized within the inventive plastic article (for instance, as mere examples, a silver substituted zeolite available from Shingawa under the tradename ZEOMIC™, and silver-containing glasses, such as IONPURE™ from Ishizuka Glass under the tradename IONPURE™, as well as AMP™ T558 and MICROFREE™, both available from DuPont, as well as JMAC™, available from Johnson Mathey). Generally, such an antimicrobial is added in an amount of from about 0.01 to 10% by total weight of the plastic composition; more preferably from about 0.05 to about 2.0%; and most preferably from about 0.5 to about 2.0% by weight of the total plastic in the shipping container. Since an antibacterial agent tends to influence inherent physical properties of resin materials and it is generally expensive, if it can give sufficient antibacterial activity, it is preferred that the content thereof be small.

The carboxylic acid salt may be any such salt based upon monovalent, bivalent, or trivalent metal ions and from C₁-C₄₀ in carbon chain length. Preferably, such at least one carboxylic acid salt is selected from the group consisting of at least one C₁-C₄₀ carboxylic acid compound neutralized by at least one cation selected from the group consisting of monovalent metal ions, bivalent ions, and trivalent metal ions. Such ions include, without limitation, monovalents such as alkali metals (e.g., sodium, potassium, lithium, and like) bivalents such as alkaline earth metals (e.g., calcium, barium, strontium, magnesium, cadmium, rubidium, and the like), zinc, tin (II), iron (II), such as aluminum, for example. Preferably, also, said carboxylic acid salt is preferably selected from the group consisting of alkali metal acetates, alkali metal stearates, alkaline earth metal acetates, alkaline earth metal stearates, zinc stearate, tin(II) stearate, aluminum stearate (as well as di- and tri-stearate), and any mixtures thereof (although other chain lengths, including myristates, behenates, oleates, palmitates, and the like, may also be utilized, these stearates and acetates are non-limiting preferred examples for this invention). Most preferred, though again, non-limiting, is calcium stearate, due to its advantages in processing as well as ultimate efficacy within the finished target thermoplastic article, as shown below. As noted above, the carboxylic acid salt should be added in amounts of from about 0.1% to 1.25% by weight, preferably from about 0.2 to about 1.0%, more preferably from about 0.2 to about 0.5%, and most preferably about 0.3% by weight of the total polymer component. Such amounts are in excess of any other acid scavenger compounds that are present within the target polymer itself (and preferably none of the carboxylic acid salts are utilized as acid scavengers in addition to this inventive purpose). In any event, such amounts are generally well in excess of standard additive amounts for acid scavenging carboxylic acid salts (such as calcium stearate, as one example) utilized within thermoplastic articles.

As noted below, the basic procedures followed in producing the inventive antimicrobial plastic article comprise standard plastic formation techniques. There are two basic methods of incorporating additives (such as silver-containing antimicrobials and the necessary carboxylic acid salts, for example) within polymer articles. One method is to dry blend a mixture of polymer, additives, antimicrobials, and carboxylic acid salt; melting the dry mix into a molten formulation which is then eventually cooled and cut into pellets; the pellets are then introduced within an injection molding machine, or other similar type of processing equipment, and ultimately cooled into a shaped article. Alternatively, one may mix conventional resin pellets and a masterbatch concentrate containing the antimicrobial and carboxylic acid salt additives and molding in conventional molding equipment. The aforementioned molding steps may be performed by injection molding, injection blow molding, injection stretch blow molding, injection rotational molding, fiber extrusion, film formation, compression molding, rotational molding, extrusion blow molding, sheet extrusion, film extrusion, cast film extrusion, foam extrusion, thermoforming (such as into films, blown-films, biaxially oriented films), thin wall injection molding, and the like into a fabricated article.

Other additives may also be used in the composition of the present invention, provided they do not interfere with the primary benefits of the invention. It may even be advantageous to premix these additives or similar structures with the silver-containing antimicrobial agent(s) and carboxylic acid salts in order to reduce their melting points and thereby enhance dispersion and distribution during melt processing. Such additives are well known to those skilled in the art, and include nucleating agents, plasticizers, lubricants, catalyst neutralizers, antioxidants, light stabilizers, colorants, acid scavengers, and the like. Some of these additives may provide further beneficial property enhancements, including improved aesthetics, easier processing, and improved stability to processing or end use conditions.

In particular, it is contemplated that the acid scavengers utilized herein are primarily not the same carboxylic acid salts as needed for the desired increase in surface-available silver on the target thermoplastic article. Thus, as one example, dihydrotalcite types (such as, primarily, through without limitation, DHT4-A from Kyowa Chemical Industry Co., Ltd.) are preferred for this purpose, thereby permitting any carboxylic acid salts to be utilized primarily for the aforementioned inventive silver-generating purpose.

The sidewalls 18, 20 and the are substantially identical to each other as are the end walls 14, 16, and therefore only one of each will be described in detail. FIG. 3 shows an embodiment where the sidewall 18 (FIG. 3) has integrally formed rails 40, 42 and stiles 44, 46 that form a peripheral, rectangular frame. The sidewall 18 has diagonal braces 48, 50 that form an X, extending from corner to corner of the frame. The X brace arrangement of the sidewalls is exemplary, and other arrangements of braces are possible depending upon the strength required for the particular application. For example, there may be more or fewer braces, and they may be diagonal as shown, at some other angle, or parallel to the rails and/or stiles.

The end wall 16 is also made with rails 52, 54 and stiles 56, 58 that are integrally formed and create a rectangular, peripheral frame. The top rail 52 of the end wall 16 includes openings 60 that form handholds for the container. Similar openings (not shown) may also be provided in the sidewalls. The end walls 14, 16 may also be provided with bracing (not shown), if the load to be carried and stacking requirements make additional bracing necessary. The bottom 12 is similar in construction to the sidewalls and is made the same manner. The bottom 12 may be made solid or with a fabric insert as shown, depending on the performance requirements for the shipper.

The shipping container has been shown with hinged walls, and this design has advantages in being able to be knocked down. However, some circumstances may require a shipper that cannot be knocked down. In that case, the shipper can be made in an integral fashion with the fabric panel inserts in one or more walls (and/or the bottom) as required. Further, the shipper need not be square. For example, the container could be made cylindrical with fabric panel inserts molded in the curved sidewall and/or bottom.

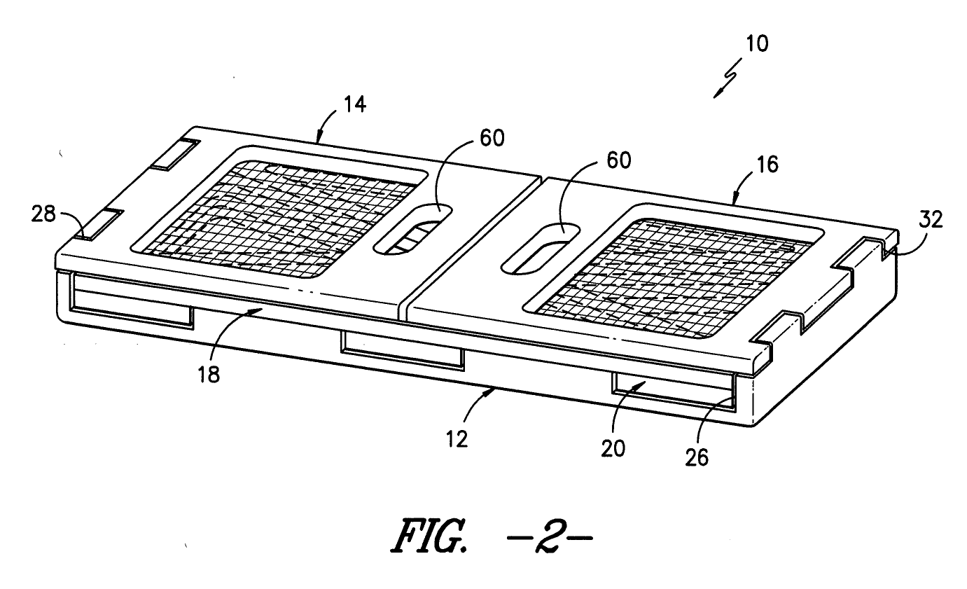

The hinges 26, 28, 30 and 32 are arranged such that the shipper may be folded flat. FIG. 2 shows the embodiment of FIG. 1 folded flat. The hinges 26, 30 on the bottom for the front and rear sidewalls 18, 20, are vertically staggered so that the sidewalls can fold flat in parallel but vertically offset planes as shown in FIG. 2. (This requires that one of the otherwise mirror image side walls be shorter than the other.) The hinges 28, 32 for the end walls are positioned upward from the bottom far enough that the end walls 14, 16 can lay flat on top of the two sidewalls 18, 20. In one embodiment, the end walls 14, 16 are short enough that they meet along the centerline of the bottom when they are folded flat. Accordingly, the hinge axes of the end walls 14, 16 are coplanar.

Any known hinge arrangement may be used so long as it permits the side walls 18, 20 and end walls 14, 16 to be folded flat against the bottom 12 and is strong enough for the intended purpose of the shipper. The hinges may be simple dimple and recess arrangements, or may have a conventional hinge pin. Other hinge arrangements in which one part snaps over another or engages another may also be used. It is only important that the hinges provide at least 90 degrees of rotation for the side walls and slightly more than that for the end walls. Further, instead of hinges any suitable latch mechanism or friction fit may be used to hold the side walls 18, 20 and end walls 14, 16 to the bottom 12. Such an arrangement would enable the shipping container 10 to break down into five separate pieces for return shipping.

To help hold the walls upright, the edges of the sidewalls 18, 20 have tabs 70 (FIG. 3) extending outward from them. Each tab 70 fits into a corresponding slot 72 in the rails of the end walls. To erect the shipping container 10 from the flat folded position shown in FIG. 2, the end walls 14, 16 are folded upward and out past their perpendicular position so that they extend away from the bottom 12 at an angle. The sidewalls 18, 20 are then folded upward until they are perpendicular to the bottom 12. Thereafter the end walls 14, 16 are folded back to a vertical position, bringing the slots 72 in the end walls 14, 16 into engagement with the tabs 70 extending from the sidewalls 18, 20.

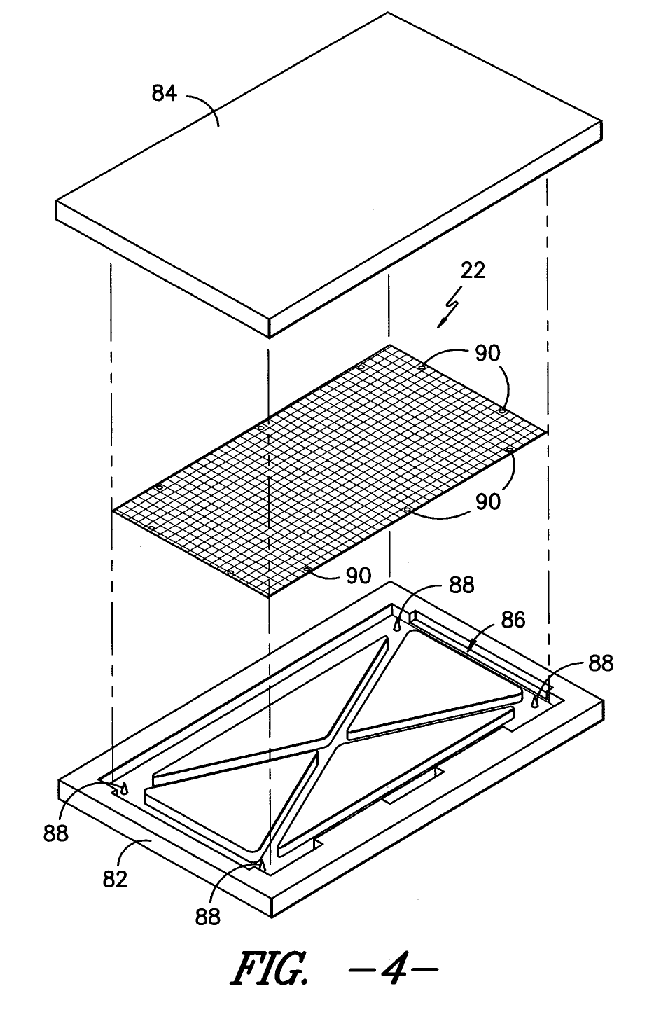

The process of making the wall 18 illustrates how the bottom 12 and the walls 14, 16, 18 and 20 are made. A conventional mold assembly, shown in FIG. 4, includes a mold bottom 82 and a mold top 84. The mold bottom 82 includes a cavity 86 the shape of the rails 40, 42, stiles 44, 46 and braces 48, 50. The mold bottom 82 also includes pins 86 positioned around the periphery of the cavity. Four pins 88 are shown, but this exemplary and more or fewer may be used. The pins 88 are shown inside the perimeter of the cavity 86 so that the edge of the fabric is buried within the finished wall. However, they could also be located outside the cavity, and then the edges of the fabric would be exposed on the outside at the mold parting line. If located within the cavity, the pins 88 may be fixed, resulting in openings through the rails and stiles. Altematively, the pins may be retractable so that no holes are formed. In another embodiment, the fabric is formed into a insert that may be inserted into the shipping container sides or bottom.

The fabric panel insert 22 is placed over the cavity and held in place by the pins 88. Thereafter the mold top is placed on top to close the mold cavity and the plastic material for making the balance of the wall is injected in the mold in a conventional manner. Because the fabric overlaps a band around the periphery of the cavity, when the thermoplastic is injected, it penetrates the fabric. The fabric panel insert has a series of perforations 90 around its margin. When the thermoplastic resin is injected into the mold cavity, it fills the perforations 90 to enhance penetration of the resin with the fabric insert 22.

It will be understood that the mold top and bottom may be reversed and either one may hold the panel 22. The resulting wall, when joined with other walls, and a bottom forms the shipping container 10 shown in FIG. 1. It is lightweight, and easy to make and use. The fabric panels can be adapted to be virtually airtight or highly permeable or anywhere in between to suit the intended use. The container 10 is easy to setup and just as easily knocked down for return and reuse.

### EXAMPLES

Fabric Antimicrobial Test

The fabric was tested for its efficacy against bacteria using the “Vial-Drop Method” (Modified MTCC Method 100). Fabric samples (20 mm in diameter) were placed in plastic jars. Samples were then exposed to bacteria (0.4 ml of 10⁵ cells/ml) suspended in 100 mM Na/K phosphate buffer+1/500 Nutrient Broth in deionized water for 22 hours at 37 C. The two bacteria tested were Klebsiella pneumoniae ATCC #4352 and Staphylococcus aureus ATCC #6538 in two separate experiments. The test conducted was the MTCC Test Method 100-1993 for 24 hour exposure

| Sample | Composition |
|---|---|
| 1 | Fabric No. 6379-100 from Milliken and Comp with coating |
| | containing 0.5% owf ALPHASAN ™ RC-5000 |
| 2 | Fabric No. 8023-064 from Milliken and Comp with coating |
| | containing 0.5% owf ALPHASAN ™ RC-5000 |
| 3 | Fabric No. 6202-640 from Milliken and Comp with coating |
| | containing 0.5% owf ALPHASAN ™ RC-5000 |

The ALPHASAN™ RC-5000 is a silver zirconium phosphates available from Milliken & Company.

TABLE 2
Kill rate log reduction compared to Untreated PET Fabric Control

| Sample | S. aureus | K. pneumoniae |
|---|---|---|
| 1 | 2.2 | 4.2 |
| 2 | 3.1 | 3.8 |
| 3 | 3.2 | 2.9 |
| Maximum value | 4.6 | 4.9 |

For all standard quantitative test methods such as AATCC Method 100, JIS L 1902, JIS Z 2801 and Milliken's Vial-Drop Screening Method, there is a maximum level of efficacy that can be measured in each test. In the simplest form, one cannot kill more bacteria than are inoculated onto a treated product. For the results above, the maximum efficacy value (maximum log reduction) is a function of the number of survivors recovered with the untreated control after 24 hrs and the minimum number of viable cells that can be counted after dilution and is a rough estimate of the number of bacteria that the samples started with.

While the present invention has been illustrated and described in relation to certain potentially preferred embodiments and practices, it is to be understood that the illustrated and described embodiments and practices are illustrative only and that the present invention is in no event to be limited thereto. While this invention is directed towards reusable plastic containers, it may also be used in fabric containers, plastic bags with or without fabric, or the like. It is fully contemplated that modifications and variations to the present invention will no doubt occur to those of skill in the art upon reading the above description and/or through practice of the invention. It is therefore intended that the present invention shall extend to all such modifications and variations as may incorporate the broad aspects of the present invention within the full spirit and scope of the invention.

What is claimed is:

1. An antimicrobial reusable plastic container comprising four sides and a base, wherein at least one of the sides or the bottom is at least partially comprises fabric, and wherein the fabric comprises an antimicrobial chemistry.

2. The antimicrobial reusable plastic container of claim 1, wherein the fabric comprises fibers with a polymeric coating, and wherein the polymeric coating comprises an antimicrobial chemistry.

3. The antimicrobial reusable plastic container of claim 2, wherein the polymeric coating comprises polyvinyl chloride or polyolefin.

4. The antimicrobial reusable plastic container of claim 1, wherein the antimicrobial comprises a silver based compound.

5. The antimicrobial reusable plastic container of claim 1, wherein the at least a portion of the sides are rigid.

6. The antimicrobial reusable plastic container of claim 1, wherein the antimicrobial is an amount of between 0.1 and 2% based on weight of the fabric.

7. The antimicrobial reusable plastic container of claim 1, wherein the fabric comprises polypropylene yarns, and wherein the polypropylene yarns comprise antimicrobial chemistry.

8. An antimicrobial reusable plastic container comprising four polymeric sides and a polymeric base, wherein the polymeric sides and base comprise an antimicrobial chemistry.

9. The antimicrobial reusable plastic container of claim 8, wherein the polymeric sides and base are injection molded.

10. The antimicrobial reusable plastic container of claim 8, wherein the antimicrobial comprises a silver based compound.

11. The antimicrobial reusable plastic container of claim 8, wherein the at least a portion of the sides are rigid.

12. The antimicrobial reusable plastic container of claim 8, wherein the antimicrobial is an amount of between 0.5 and 2% based on weight of the polymeric sides and base.

13. An antimicrobial reusable plastic container comprising four polymeric sides and a polymeric base, wherein at least one of the sides or the bottom is at least partially comprises fabric, and wherein the polymeric sides, polymeric base, and the fabric comprise an antimicrobial chemistry.

14. The antimicrobial reusable plastic container of claim 13, wherein the fabric comprises fibers with a polymeric coating, and wherein the polymeric coating comprises an antimicrobial chemistry.

15. The antimicrobial reusable plastic container of claim 13, wherein the antimicrobial comprises a silver based compound.

16. The antimicrobial reusable plastic container of claim 13, wherein the antimicrobial comprises a silver zirconium phosphate.

17. The antimicrobial reusable plastic container of claim 13, wherein the at least a portion of the sides are rigid.

18. The antimicrobial reusable plastic container of claim 13, wherein the sides have hinged connections to the base, the sides having an erect condition wherein they together with the base define a generally rectangular, open topped container and a knocked down condition in which the sides are folded flat on top of each other and the base.

19. The antimicrobial reusable plastic container of claim 13, wherein at least one side is injection molded around the fabric.
